(19) United States
(12) Patent Application Publication
(10) Pub. No.: US 2002/0096850 A1
(43) Pub. Date: Jul. 25, 2002

(54) Kick scooter rear fender structure

(76) Inventor: Zichin Lu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/766,603

(22) Filed: Jan. 23, 2001

(51) Int. Cl. B62M 1/00

(52) U.S. Cl. 280/87.042

(57) ABSTRACT

A kick scooter rear fender structure includes a footplate holding a rear wheel, a stop block pivoted to the footplate in front of the rear wheel for pressing by the foot to stop the rear wheel from rotation, two holder plates fixedly fastened to the footplate and equally spaced from the rear wheel at two opposite lateral sides, and a foot block fixedly connected between the holder plates and spaced above the rear wheel for the stepping of the feet when the user performing a stunt riding.

### BACKGROUND OF THE INVENTION

The present invention relates to kick scooters and, more specifically to a rear fender structure for a kick scooter, which enables the kick scooter rider to perform a stunt riding.

Regular kick scooters commonly have a rear fender adapted to protect the rear wheel against splashing mud, collision, etc. The rear fender can be of fixed type, or movable type. A movable rear fender can be served as brake means for pressing by the foot to stop the rear wheel from rotation. FIGS. 1A and 1B show the arrangement of a movable rear fender for a kick scooter. As illustrated, a pivot 4 pivots the rear fender 3 to the rear side of the footplate 1, keeping the rear fender suspended over the rear wheel 2, and a spring plate 6 is fastened to the footplate 1 by a screw 5 to support the rear fender 3 above the rear wheel 2. Because the rear fender 3 has only a rear part supported on the spring plate 6, it vibrates and rubs against the periphery of the rear wheel when the user rides the kick scooter over an uneven road surface. Further, the rear fender cannot support the gravity weight of the user for enabling the user to perform a stunt riding.

### SUMMARY OF THE INVENTION

The present invention has been accomplished to provide a kick scooter rear fender structure, which eliminates the aforesaid drawbacks. According to one aspect of the present invention, a stop block is pivoted to the footplate of the kick scooter in front of the rear wheel for pressing by the foot to stop the rear wheel from rotation, two holder plates are fixedly fastened to the footplate and equally spaced from the rear wheel at two opposite lateral sides, and a foot block is fixedly connected between the holder plates and spaced above the rear wheel for the stepping of the feet when the user performing a stunt riding. The stop block, the holder plates and the foot block protect the rear wheel against splashing mud, collision, etc. Because the foot block is fixedly connected between the holder plates, it does not vibrate when the user rides the kick scooter. According to another aspect of the present invention, the holder plates each have a serrated anti-skid top edge, and the foot block has a serrated anti-skid top sidewall.

### BRIEF DESCRIPTION OF THE DRAWINGS

FIG. 1A illustrates the arrangement of a rear fender at the rear side of a footplate over a rear wheel according to the prior art.

FIG. 1B illustrates the rear fender pressed against the periphery of the rear wheel according to the prior art.

FIG. 2 is an exploded view of the present invention.

FIG. 3A is a sectional view of the present invention, showing the stop block spaced from the rear wheel.

FIG. 3B is a top view of FIG. 3A.

FIG. 4 shows the stop block depressed against the periphery of the rear wheel according to the present invention.

FIG. 5 is an applied view of the present invention, showing the performance of a stunt riding.

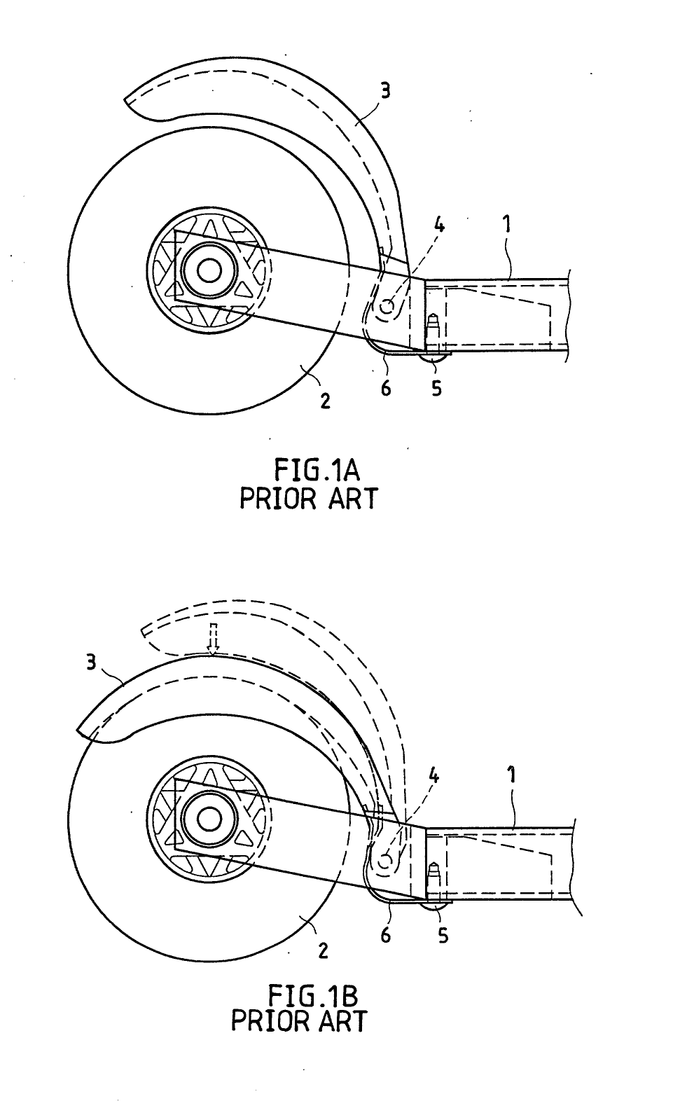

### DETAILED DESCRIPTION OF THE PREFERRED EMBODIMENT

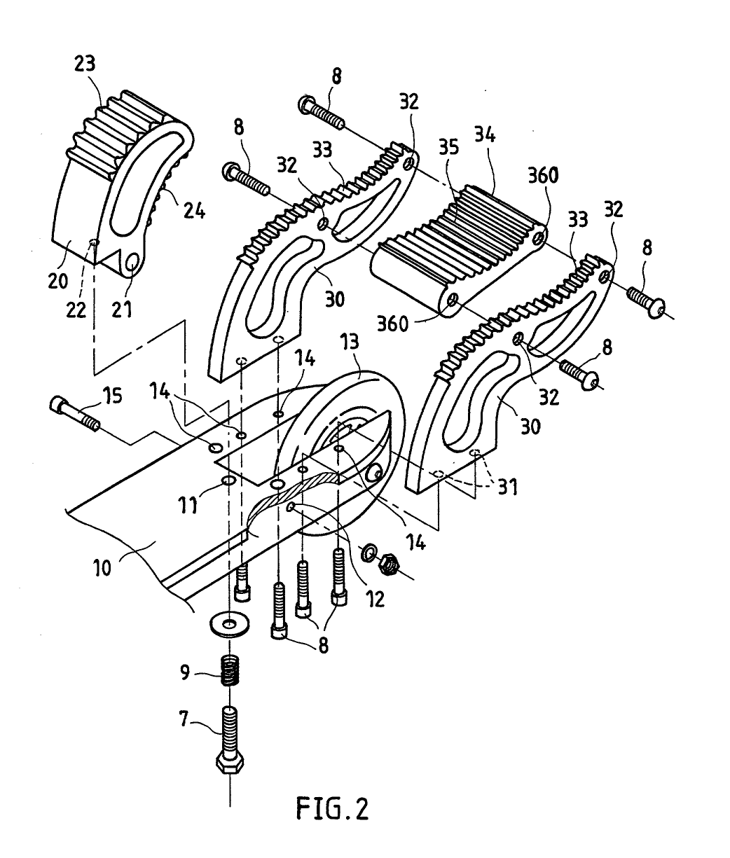

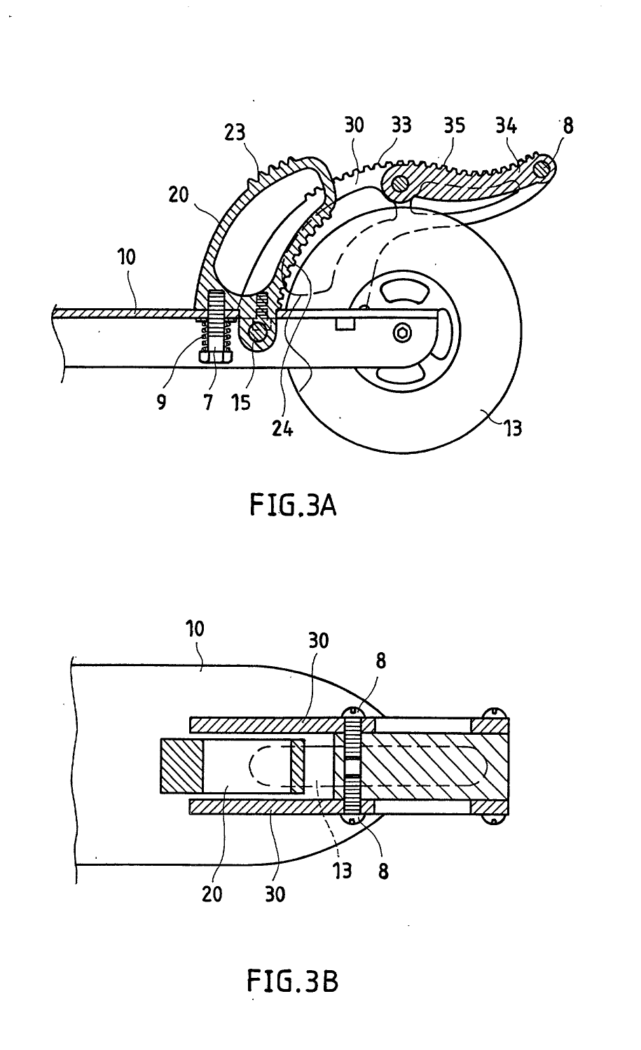

Referring to FIGS. 2, 3A and 3B, a rear wheel 13 is pivoted to the rear side of a footplate 10. The footplate 10 comprises a vertical through hole 11 disposed in front of the rear wheel 13, two horizontal pivot holes 12 transversely aligned at two sides between the vertical through hole 11 and the rear wheel 13, and two longitudinal rows of vertical mounting holes 14 arranged at two sides of the rear wheel 13. An arched hollow stop block 20 is pivoted to the footplate 10 and suspended above the front side of the rear wheel 13. The stop block 20 comprises a pivot hole 21 transversely disposed at one end, namely, the bottom end thereof and pivotally connected between the horizontal pivot holes 12 of the footplate 10 by a screw bolt 15, and a bottom hole 22 disposed at the bottom end adjacent to the pivot hole 21, and transverse rids 23 and 24 arranged over the front and back sidewalls thereof. A screw bolt 7 is inserted through the vertical through hole 11 of the footplate 10 and threaded into the bottom hole 22 of the stop block 20. A compression spring 9 is mounted on the screw bolt 7 and stopped between the head of the screw bolt 7 and the bottom sidewall of the footplate 10. Two holder plates 30 are mounted on the footplate 10 and disposed at two sides of the rear wheel 13. The holder plates 30 each comprise a plurality of vertical bottom mounting holes 31 respectively fastened to the vertical mounting holes 14 of the footplate 10 by respective screws 8, a plurality of transverse mounting holes 32, and a serrated top side edge 33. A foot block 34 is connected between the holder plates 30 and suspended above the rear wheel 13 behind the stop block 20. The foot plate 34 comprises a plurality of transverse mounting holes 360 respectively connected between the transverse mounting holes 32 of the holder plates 30 by respective screw bolts 8, and a serrated anti-skid top sidewall 35 for the positioning of the feet positively.

Referring to FIGS. 3A and 3B again, normally, the spring 9 imparts a downward pressure to the head of the screw bolt 7, causing the stop block 20 to be held away from the rear wheel 13, and therefore the rear wheel 13 can be freely rotated.

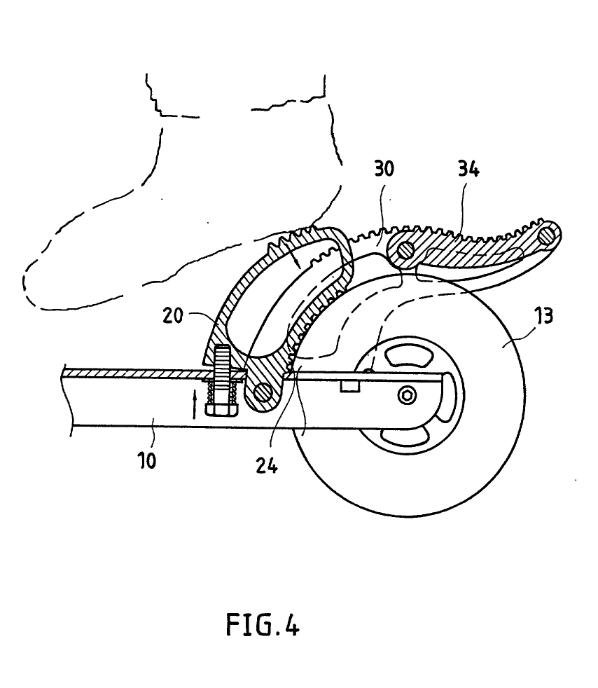

Referring to FIG. 4, when the user presses the stop block 20 backwardly downwards against the periphery of the rear wheel 13 with the foot, the rear wheel 13 is stopped from rotation.

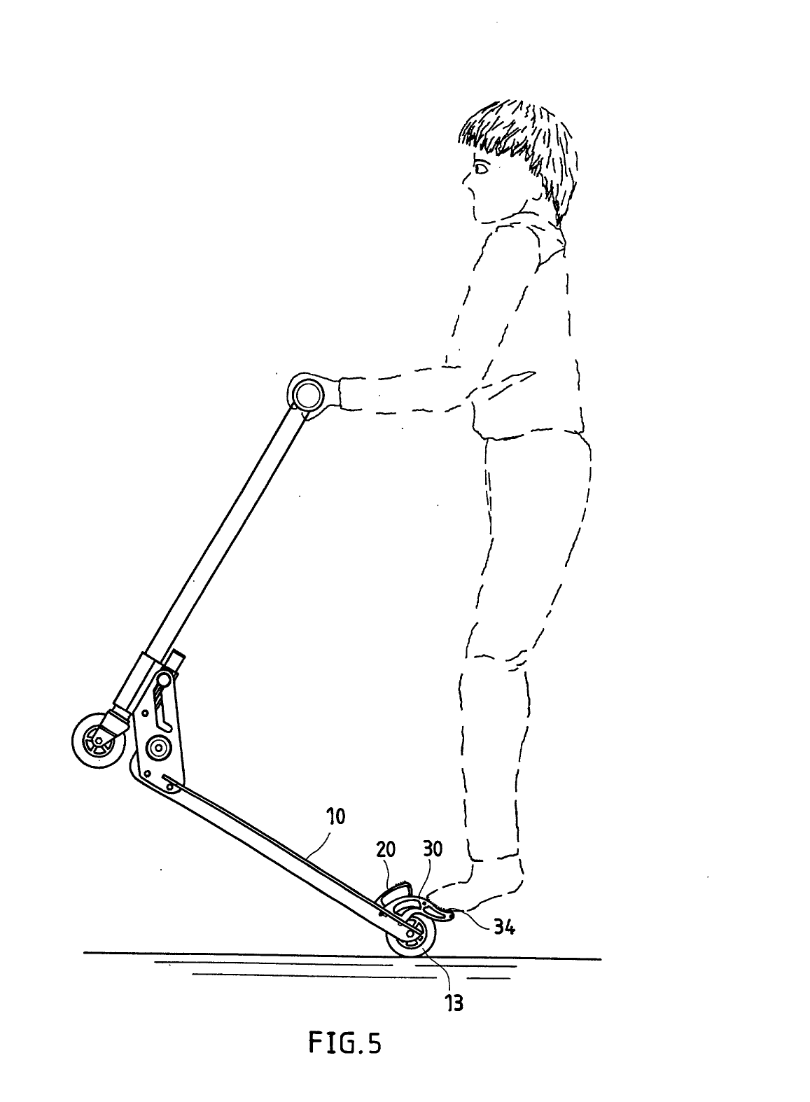

Referring to FIG. 5, the user can step on the foot block 34 to tilt the kick scooter and to lift the handlebar and front fork unit of the kick scooter upwards from the floor, so as to perform a stunt riding. Because the foot block 34 is fixedly connected between the holder plates 30 above the rear wheel 13, it is strong enough to support the user above the rear wheel 13 without hindering free rotation of the rear wheel 13. Because the holder plates 30 have a respective serrated top side edge 33 and the foot block 34 has a serrated anti-skid top sidewall 35, the user can step on the foot block 34 positively.

While only one embodiment of the present invention has been shown and described, it will be understood that various modifications and changes could be made thereunto without departing from the spirit and scope of the invention disclosed.

What the invention claimed is:

1. A kick scooter rear fender structure comprising a footplate holding a rear wheel, a stop block pivoted to said footplate in front of said rear wheel for pressing by the leg to stop said rear wheel from rotation, and a rear fender unit fastened to said footplate over said rear wheel behind said stop block, wherein said stop block comprises a plurality of transverse ribs arranged over front and back sidewalls thereof; said rear fender unit comprises two holder plates fixedly fastened to said footplate and equally spaced from said rear wheel at two opposite lateral sides, and a foot block fixedly connected between said holder plates and spaced above said rear wheel for the stepping of the feet when the user performing a stunt riding.

2. The kick scooter rear fender structure of claim 1, wherein said holder plates each have a serrated anti-skid top edge, and said foot block has a serrated anti-skid top sidewall.
